(19) United States
(12) Patent Application Publication
(10) Pub. No.: US 2009/0282355 A1
(43) Pub. Date: Nov. 12, 2009

(54) System and Method for Systematically Locating Points on a Geometric Diagram

(76) Inventor: Chung-Tyan HSIEH, Taipei City (TW)

Correspondence Address: HDLS Patent & Trademark Services, P.O. BOX 220746, CHANTILLY, VA, 20153-0746, US

(21) Appl. No.: 12/117,120

(22) Filed: May 8, 2008

(51) Int. Cl. G06F 7/00; G06F 17/30; G06F 3/048

(52) U.S. Cl. 715/771; 707/101; 707/E17.006

(57) ABSTRACT

In integrated circuits design, a system performs the task for systematically locating geometric points, which contains particular features and registry labels. The application can parse the position data of all the labels into corresponding grouping, and then export the information of labels to pre-defined data fields. User may define macros to select the records they want, and, through an interface on the workstation, translate them into messages in particular format. The tool, upon receiving the messages, would follow the instructions to carry out the tasks at the word of command.

### BACKGROUND

The minimum feature sizes of integrated circuits have been shrinking for years. Commensurate with this size reduction, various limitations have emerged and brought formidable obstacles for IC fabrication to tackle. One problem the fabrication technology encounters is in photolithography.

An integral component photolithographic apparatus is a “mask” that includes a pattern corresponding to features at one layer in an IC design. As light passes through the mask, it is refracted and scattered by the chromium edges. This causes the projected image to exhibit some rounding and other optical distortion, which would induce many unexpected problems for the final products.

To remedy this problem, the operators must, for example, collect lots of experimental data at some specific points of the products. These data may include inspecting, monitoring purpose. Generally, the target design comprises countless patterns in it. The file size may be several gigabytes or more in stream format. Locating the points with a particular feature on the design becomes very difficult because of such a big file size, in which the methodology “pattern recognition” is out of the question to find all the particular features in the design.

Accordingly, what is needed is a method and system that can systematically locate the geometric position of points in the target design. The presented invention addresses such a need.

### SUMMARY

An Index system for locating specific position of a design is proposed here. In this system, all the design data are stored by using an encoded combination of stream describing the information pertained to the design. The encoded geometric data can be extracted by means of coordinate transformation and, if necessary, exported to a new coordinate system for a new design. In the process, the relative positions of all labels won't be muddled.

The whole set of design data can be transformed into a specific data structure, in which the contents of the labels can be stored, located, exported through a series of transformation.

The presented invention provides a method and system for systematically locating geometric position of points in a target design. The target design may contain countless patterns. Preferably, the target design is described in an electronic stream format, e.g., GDS II, which may represent individual features in the design as a set of (x, y) points. It also can register the labels on the diagram at a specifying of (x, y) point. The labels can encrypt information, to specify a task. While the target design is manufactured as products, it seems a copy of target design. All of labels can be parsed from the file stream under a coordinate system, and export the absolute position of points and individual information to database. The specifying points can be queried out to process the defined task. That's says, any of task can be synchronize at the products for referring the records on the database.

### DESCRIPTION OF THE DRAWINGS

The invention can be more fully understood with the following detailed description and examples with references to the accompanying drawings, wherein:

FIG. 1 is a schematic view of an embodiment of a systematically locating the position of features in the target design.

FIG. 2 is a flow diagram of an embodiment of a label-parsing procedure.

FIG. 3 is a flow diagram of an embodiment of a methodology to translate any feature of the original diagram into a new design diagram with a new coordinate system.

FIG. 4 is a flow diagram of an embodiment of parsing the labels on the target design into the records, and saving the result to a database on the workstation.

FIG. 5 is a flow diagram of an embodiment of extracting the record from the database, and translating it into messages with particular format.

### DETAILED DESCRIPTION

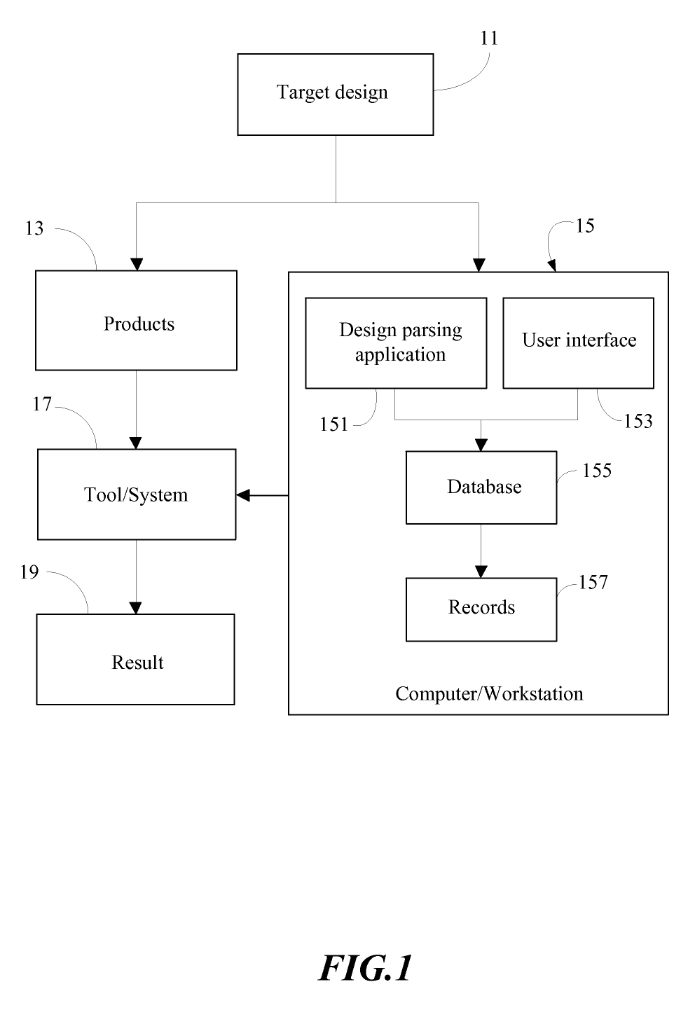

Exemplary embodiments of invention will now be described with reference to FIGS. 1 through 5. The following description is presented to enable one of ordinary skill in the art to make and use the invention and is provided in the context of a patent application and its requirements. Various modifications to the preferred embodiments and the generic principles and features described herein will be readily apparent to those skilled in the art. Therefore, the present invention is not intended to be limited to the embodiments shown, but is to be accorded the widest scope consistent with the principles and features described herein.

FIG. 1 is a schematic view of an embodiment of system for locating a position of points on target design. The system 10 includes a label parsing software application 151 executing on processor in a computer/workstation 15 or a server that is accessed over a network (not shown). The workstation 15 preferably includes a microprocessor that is coupled to a non-volatile storage device, e.g., a conventional hard disk storage device. The microprocessor and the hard disk storage device are coupled on to a volatile storage device, e.g. a random access memory (RAM). A monitor may be coupled on to the workstation for displaying a user interface.

Inputs to the parsing application 151 are a target design 11. Preferably, the target design 11 is described in an electronic stream format e.g., GDS II, which may represent individual features in the design as a set of (x, y) points and labels that specifies positions. The workstation 15 will export records that specify the (x, y) point on the design 11, which may instruct the tool 17 to process a defined task on the product 13, and derive the result 19.

According to the preferred embodiment, the parsing application 151, analyzing the target design 11, may export a string that can be decrypted into information and absolute positions to be written to a database 155. Users can input particular requirements to inquire data of the database, and export the records 157 through the interface 153. Each of the records will instruct the tool 17 to process a specifying task. For example, locate a point on the product 13 to measure an experimental data, and report it as result 19.

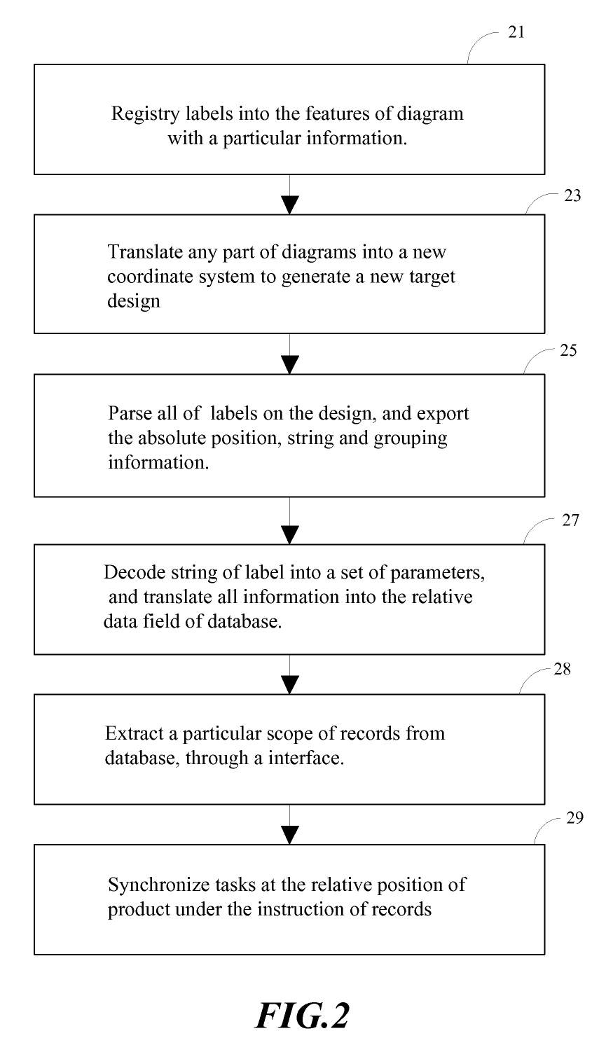

FIG. 2 is a flow diagram illustrating the process for systematically locating the geometric points of features in a target design for experimental data collection according to a preferred embodiment. The target design comprises countless features, each of which may bring with it a label to specify a task at the point in step 21. Part of the features of different diagrams may be translated into a new diagram in step 23. The relative coordinates of labels and patterns in the original of coordinate system will not be changed. After the translation, all of the points will designate new positions, including the position of labels. The position of labels may contain an absolute position on the new coordinate. The parsing application can export the positions and information that are encrypted in the string in step 25 of label. The information can then be decrypted into sets of parameters and saved to relative data field on the database in step 27.

According to the requirements of users, the particular record may be extracted, which may point to the specified position of features on target design in step 28, each piece of information may instruct a task for the point in step 29. The tool 17 can read the information from the output of workstation 15, process each instruction in the records, and carry out the task to export the data to specified functional tool.

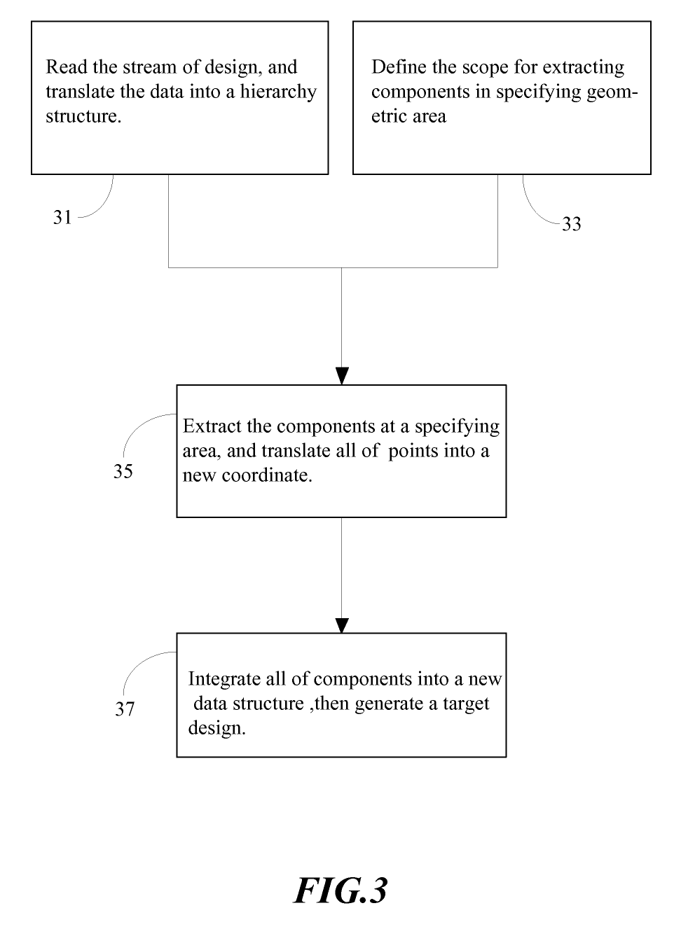

FIG. 3 is a flow diagram illustrating the process that a part of diagrams is translated into a target design 11. The target design represent set of (x, y) points and registry label with a (x, y) point. The application can read the stream and expand it into a hierarchical data structure in step 33. Users can choose any part of the diagram on purpose in step 35. Geometrically, any point can be selected by the defined scope in step 37. The points coming from different coordinate systems can be translated into a new coordinate system by coordinate transformation in step 38. Transformations can conveniently be performed by using matrix arithmetic. For each transformation, there is a transformation matrix T such that Q_{b}=TQₐ, where Qₐ is a vector in the first coordinate system, and Q_{b} is the corresponding vector in the second coordinate system. The transformation is thus described by the components of the matrix T. The coordinate transformation was well known in the methodology of linear algebra, and there is not any limitation in applying coordinate system to translate the points of diagram into a new coordinate system. All of data may be stored in a data structure and exported to a target design in step 39.

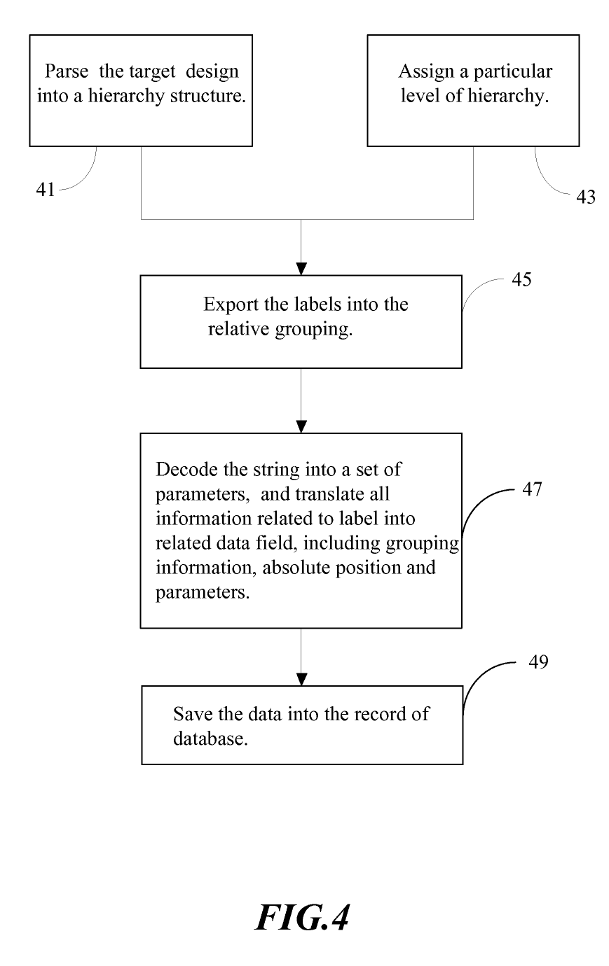

FIG. 4 is a flow diagram illustrating the process for exporting the record to target design. The data stream can be expanded to many types of data structure

The data stream of target design can be expanded to a hierarchical structure in step 43. The labels and features can be attached to a specific end node of structure. Users can select a level of hierarchy and to export all the labels below that hierarchy in step 43. All the labels can be exported to a group of nodes, according to the level of hierarchy in step 45. The information of labels shall include a string, an absolute position and grouping information. The string may be translated into specific data fields on the basis of a defined data structure in step 47. The data in the fields of this structure are represented by some parameters, e.g., integer, float, characters. Each piece of data in the label will be saved to the database as a record in step 49.

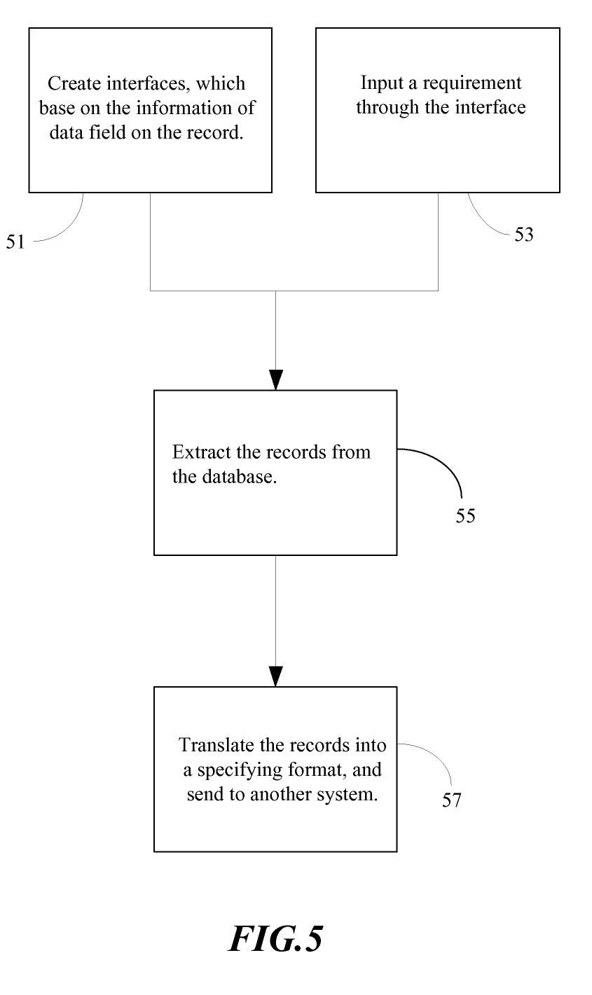

FIG. 5 is a flow diagram illustrating the process of extracting records from the database. User can define any kind of strategy to extract the records from database in step 51. Some macros, using logic operators defined in step 53, can be used to extract data. Finally, the records may be translated to the tool with messages in a particular format in step 55. The messages can be a file or a data link in the network, and then translated to the tool in step 57. The tool will follow the instruction of messages to perform the specific tasks.

While the invention has been described by way of examples and in terms of several embodiments, it should be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for systemically locating geometric points on a design diagram, comprising:
a data structure for reading design data and converting the data into another specific data structure, in which all the data is arranged by a hierarchical structure;
a storage device for storing the data of a database; and
an interface for allowing users to extract a specific range of data and to convert into information that is read by other systems.

2. The system of claim 1, further including a context of target design which includes a series of designs, all the position data stored in which being translated to a new set of points in another coordinate system.

3. The system of claim 2, further including a code which can read in a design in stream format, and expand all elements into the hierarchical structure, and labels are represented with an end-node structure which is the lowest level in the hierarchy.

4. The method of claim 3, further including an exportation in which the code exports labels located in a particular level of nodes to a corresponding data group.

5. The system of claim 4, further including a translation in which the code translates the strings of label into a pre-defined data structure and data field of the structure includes a set of parameters of integer, float and characters.

6. The system of claim 5, further including a storage in which the data record translated by the code is saved to a database on a workstation, and data fields include grouping information, absolute position and parameters.

7. The system of claim 6, further including a display with which the code shows the grouping diagram in graphic interface, and user can select any group with an input device on the workstation.

8. The system of claim 7, further including an extraction, in which the code reads in a macro and uses the command hidden therein to extract a particular set of records from database, and then translates into messages, in a particular format of file or data links in the networking.
